(19) United States
(12) Patent Application Publication
(10) Pub. No.: US 2012/0331074 A1
(43) Pub. Date: Dec. 27, 2012

(54) Trusted Electronic Communications

(75) Inventors: Gregory Steven Fox, Richmond, CA (US); Barton Evan Schaefer, Novato, CA (US)

(73) Assignee: iPost, San Rafael, CA (US)

(21) Appl. No.: 13/530,713

(22) Filed: Jun. 22, 2012

Related U.S. Application Data
(60) Provisional application No. 61/500,991, filed on Jun. 24, 2011.

(51) Int. Cl. G06F 15/16

(52) U.S. Cl. 709/206

(57) ABSTRACT

A first party provides a key phrase to a second party so that the second party can later initiate and send an electronic communication, such as an email message, to the first party with the key phrase included, typically in a prominent fashion such as in the subject line of the email message. In this way, the first party recipient of the email message can readily tell that the electronic communication was sent by the second party sender of the email message thus providing a measure of trust in the electronic communication.

### CROSS-REFERENCE TO RELATED APPLICATIONS

This application claims priority of U.S. Provisional Patent Application No. 61/500,991, entitled “Trusted Communication Labeling” and filed Jun. 24, 2011, the disclosure of which is incorporated herein by reference in its entirety.

### BACKGROUND OF THE INVENTION

1. Field of the Invention

The present invention relates generally to communication of electronic messages and, in particular, to communication of email messages.

2. Description of the Prior Art

In today's digital world, communications are often accomplished through electronic means such as electronic mail (email) or text messaging rather than face-to-face interactions. While the ease and convenience of communicating electronically has dramatically increased the amount of interaction possible, it has also increased the opportunity for deception by unscrupulous senders of such electronic communications.

One known form of deception utilized by some senders of electronic communications is commonly known as phishing. Phishing is attempting to acquire information (and sometimes, indirectly, money) such as usernames and passwords, and in some instances bank account information and/or credit card details, by masquerading as a trustworthy entity in an electronic communication.

Such phishing attempts often target customers of banks, credit card companies and other online payment services. For example, a phisher hoping to gain online access to a bank customer's account might send the customer an email that has the appearance of being sent from the bank and that asks the customer to click on a link in the email to log-on (otherwise known as log-in, sign-on or sign-in) to their bank account for some stated purpose (e.g., to confirm some billing or transaction information). However, rather than directing the bank customer to a legitimate webpage of the bank, the link directs the bank customer to a fake webpage that only looks like a webpage of the bank and is, instead, controlled by the phisher. As a result, when the bank customer then enters their log-on information (e.g., user name and password) on the fake webpage the phisher thereby obtains the customer's log-on information. Having that bank customer log-on information means the phisher can then use that information to log-on to the bank, effectively posing as the bank customer, to thereby conduct any of the online bank transactions available to that customer transfer funds out of an account, charge transactions to the account, open new credit accounts and charge transactions against them, etc.).

Various approaches have been used to avoid such phishing attempts. One known approach is to recognize that some institutions simply do not use email, or other forms of electronic communication, to request a customer log-on for any such purposes. For example, credit card companies generally do not send emails to their customers asking them to log-on to verify some transaction. Instead, if they have a question about a particular transaction, they will simply call their customer on the telephone or send them a letter via the regular postal service. As such, simply being aware that any email purporting to be from a credit card company and asking for such transaction confirmation is untrustworthy on its face and should simply be ignored.

Another known approach to avoiding such phishing attempts involves the use of Secure Socket Layer (SSL) authentication to ensure that the website one is visiting is legitimate. Customers are then warned to look for an indication of use of such SSL authentication before entering confidential information such as a username or password.

A still further known approach to avoiding such phishing attempts, or at least to ensure that the website a bank customer visits is the legitimate website of the bank, requires its customers to first establish certain security measures before being able to log-on to access one's account(s) with that bank online. In particular, in addition to providing an online user name or identification (ID), and password, the customer must first select an image from one of a number of images displayed on the bank's initial online setup webpage(s). Further, the bank also asks the user to provide a user-generated title for the selected image. Lastly, also as part of this initial security set-up process, the bank also stores a web browser cookie on the customer's computer.

Then, whenever the customer later tries to log-on to the bank's website by entering their user name/ID on the bank's website, the bank's server first looks for the stored cookie to ensure the computer presently being used by the customer is the same one previously used by the customer. Next, the bank's server sends the image the customer previously selected, along with the customer provided image title, to the customer's computer for display as part of the bank's log-in webpage. It is only then that the customer is asked to provide their password to complete the log-on process. Once logged-in, the customer can then access their online accounts with the bank.

As a further security measure, the bank warns their customers to never enter their password until after they see their selected image and provided image title on the bank's website. This makes for a more secure banking transaction because it would be very difficult for a phisher to be able to independently fake those items. And the bank only electronically communicates to the customer the customer selected image and customer provided title in response to the customer initiating the log-on process and entering their user name/ID as part of the bank's web-based log-on process. As such, even if a phisher did somehow learn of the customer selected image and provided image title and wanted to use them to deceive the bank customer into logging into a phisher's fake webpage, the phisher still could not use them to initiate some new electronic communication (e.g., email) to the bank customer because the bank customer would immediately recognize it as a deception since it does not properly follow the bank's log-on process.

So, while known phishing electronic communications can be thwarted or avoided in a number of instances, a problem still remains in knowing that a received electronic communication is from a desired or known sender. Clearly, if a recipient could readily tell that a received email is from a sender known to the recipient essentially eliminates the possibility that the email is from a phisher and significantly improves the likelihood that it will be read by the recipient.

What is needed, therefore, is a way to improve electronic communications so that a recipient can readily ascertain that an electronic communication is from a sender known to the recipient and is therefore a trusted communication.

### SUMMARY

In one embodiment is provided a trusted electronic communication method comprising: generating, by a computing device of a message sender, an email message to be sent to a computing device of a message recipient wherein the email message is not part of an existing electronic communication message thread with the message recipient; retrieving, by the computing device of the message sender, a stored key phrase previously provided by the message recipient; adding, by the computing device of the message sender, the retrieved key phrase to a prominent location within the email message; and sending, from the computing device of the message sender to the computing device of the message recipient, the email message with the added key phrase. In a further embodiment of the method a DKIM header field is added to the email message after the step of adding the key phrase to a prominent location within the email message and before the step of sending the email message with the added key phrase.

In yet another embodiment is provided a non-transitory computer readable medium having stored thereupon computing instructions comprising: a code segment to generate, by a computing device of a message sender, an email message to be sent to a computing device of a message recipient wherein the email message is not part of an existing electronic communication message thread with the message recipient; a code segment to retrieve, by the computing device of the message sender, a stored key phrase previously provided by the message recipient; a code segment to add, by the computing device of the message sender, the retrieved key phrase to a prominent location within the email message; and a code segment to send, from the computing device of the message sender to the computing device of the message recipient, the email message with the added key phrase.

### BRIEF DESCRIPTION OF DRAWINGS

FIG. 1 is a block diagram of a system for trusted electronic communications according to one embodiment.

FIG. 2 is an exemplary process flowchart of a method for trusted electronic communications according to one embodiment.

FIG. 3 is a block diagram illustrating an exemplary email message as may be created for a trusted electronic communication.

FIG. 4 is a block diagram illustrating an exemplary email message as may be modified for a trusted electronic communication.

### DETAILED DESCRIPTION OF THE INVENTION

Described herein are various embodiments of a method and system whereby a first party provides a key phrase to a second party so that the second party can later initiate and send an electronic communication (e.g., an email) to the first party with the key phrase included, typically in a prominent fashion. In this way, the first party (the recipient of the electronic communication) can readily tell that the electronic communication was sent by the second party (the sender of the electronic communication) thus providing a measure of trust in the electronic communication,

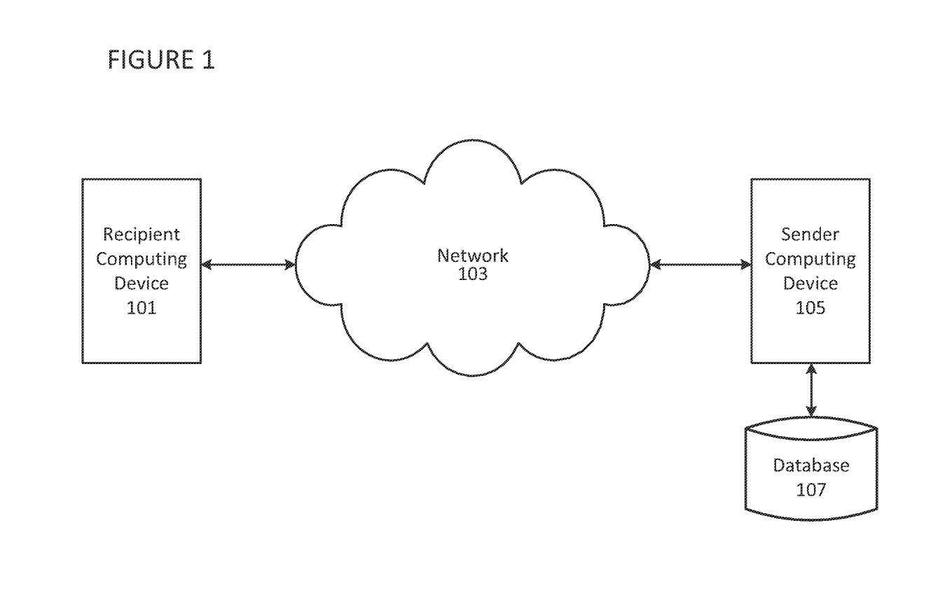

One embodiment of the present approach will now be described with reference to FIG. 1. A recipient computing device 101 is shown connected to a sender computing device 105 via a network 103. In one example, recipient computing device 101 is a computing device, e.g., a personal computer, tablet or smartphone, running an email application program and a web browser application program. Likewise in this example, sender computing device 105 is a computing device, e.g., a server, running an email application program and a web server application program. In this example, network 103 is the Internet.

A recipient operating recipient computing device 101 and desiring to establish trusted electronic communications with a sender operating sender computing device 105 first provides the sender with the recipient's email address and a key phrase which is then saved by sender computing device 105 in a database 107. Later, when the sender decides to send such a trusted email electronic communication to the recipient, the sender computing device retrieves the recipient provided key phrase from database 107 and adds it to the generated email, typically placing it in a prominent location within the email, before sending the email to recipient computing device 101 across network 103. In this way, when the email is received by recipient computing device 101, the recipient can readily ascertain that the email was sent from sender computing device 105 by confirming inclusion of the recipient provided key phrase in the received email.

The shared knowledge of the recipient provided key phrase is designed to establish trust and value between the parties so that the sender can communicate with the recipient using otherwise ordinary asynchronous communication channels which are not part of an existing message thread. This can be particularly useful in situations where the sender wishes to make repeated contact with the recipient without an existing conversational thread. That is, situations where the sender desires his communication to be considered trustworthy or valuable on the basis of a recognizable existing relationship with the recipient, rather than based on the recipient having to examine the entirety of the content of the received electronic communication.

The existence of such a relationship is valuable to both the sender and the recipient. To the recipient, it provides the advantage of quickly and in some embodiments automatically distinguishing a given sender from other correspondents. To the sender, it offers the promise that the communication is welcomed by the recipient, and an independent confirmation that the recipient has agreed to receive communications from the sender. Experience has shown that a message from a recognized source is significantly more likely to attract attention and that a message from a sender with whom such a relationship has been established by a recipient is more likely to obtain a desired response from the recipient.

It is to be understood that recipient provided key phrases, as that term is used herein, can be any alpha, numeric or alphanumeric text string created or determined by the recipient. This ensures that a third party cannot masquerade as the sender by manufacturing a key phrase, because any third party manufactured key phrase is unlikely to match the real key phrase created by the recipient. Further, this makes it unlikely that two recipients will have identical key phrases, so that in the event the key phrase of one recipient is discovered by such a third party, that discovery is not useful should the third party attempt to masquerade for any other recipients.

As for the content of the key phrase itself, in one example, the key phrase can be a word or statement that has meaning to or can be readily recognized by the recipient such as “We love your hats' or “Semper Fi”. In another example, the key phrase can be any nonsensical statement not commonly used such as “bashful radishes”. In still another example, the key phrase can simply be a string of characters having no particular significance or meaning such as “ab3Et2Uq0”.

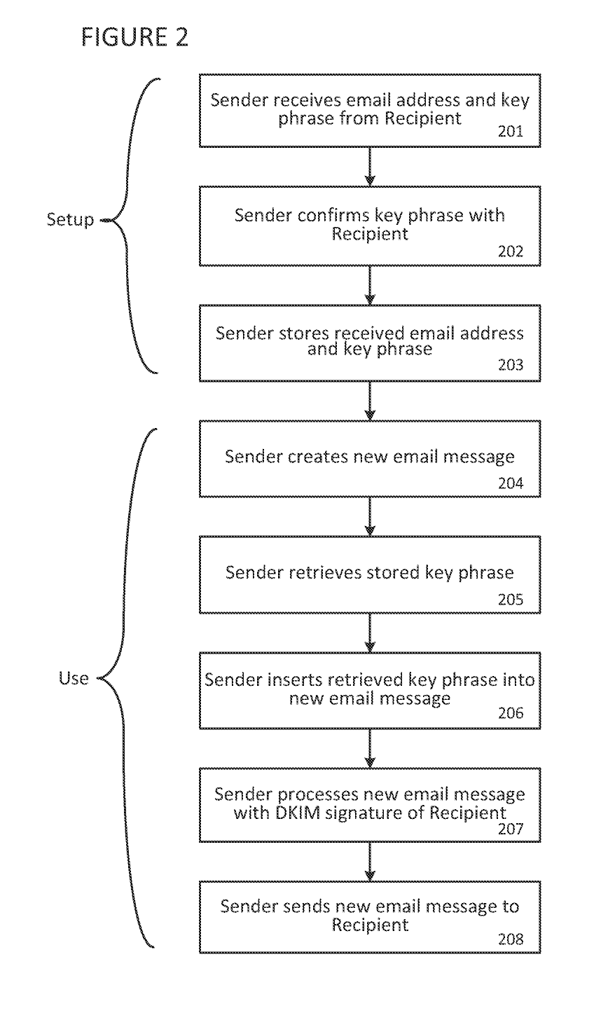

Referring now to FIG. 2, the above described process and various options, alternatives and further details will now be explained.

In step 201, sender receives recipient's email address and key phrase.

In one embodiment, this is accomplished by recipient entering and submitting such information in a single operation such as, for example, by recipient entering such information into a form webpage that generates a HyperText Transfer Protocol (HTTP) Post command, a command known in the art, which both communicates the information to sender computing device 105 and also stores it in database 107 as explained elsewhere herein.

In a further embodiment, the sender receives the recipient's email address and key phrase in two separate operations, that is, the sender receives the recipient's email address in a first operation and then receives the recipient's key phrase in a later, second operation. In one example, the first operation is via a first webpage HTTP Post command and the second operation is via a second, separate webpage HTTP Post command. In another example, the first operation is a manual operation where the sender receives the recipient's email address in a hardcopy form (e.g., via entry into a hardcopy form or other physical document) which is then manually entered into sender computing device 101 (see FIG. 1) and the second operation is a form webpage HTTP Post command or via receipt of yet another hardcopy form or document. In a still further example, the first operation is either via a first webpage HTTP Post command or some manual operation and the second operation is then via a Point of Sale (POS) device operated either by recipient or some other operator of the POS device such as a clerk, cashier, manager or other agent of sender. In a yet further example, the first operation, whether automated, manual, or some combination of both, is included as part of a process of creating or providing a unique identification (ID) for the recipient such as a user ID, customer ID, employee ID, student ID, etc., and the second operation uses the unique ID to correlate the then-known recipient email address to the now-provided recipient key phrase.

In optional step 202, sender confirms with recipient the received key phrase.

In one embodiment, this is accomplished by sender using sender computing device 105 to send an email across network 103 to recipient computing device 101 using the recipient provided email address and wherein the email contains both the recipient provided key phrase and a confirmation link. The email asks the recipient to click on the confirmation link in order to confirm that the included recipient provided key phrase is correct. The recipient, using recipient computing device 101, then clicks on the confirmation link which causes a command (e.g., an HTTP Post command) to be communicated back to sender computing device 105 that the key phrase has been confirmed. Such confirmation informs sender computing device 105 to use the confirmed key phrase in future email communications to be sent via recipient's email address to recipient computing device 101.

In step 203, sender computing device 1 stores the received recipient email address and key phrase.

In one embodiment, this is accomplished by sender computing device 105 storing this information (e.g., via the HTTP Post command) in database 107 as shown in FIG. 1 although it is to be understood that any known data storage technique and/or apparatus can be used for such storage. In an alternative embodiment, rather than being directly connected to sender computing device 105, database 107 is part of a separate computing device or system, such as a database server or system, with which sender computing device 105 communicates. Although not shown in the figure, in such alternative embodiment, it is to be further understood that such communication between sender computing device 105 and the separate computing device or system is either via a direct connection between them, via a local or wide area network to which they are both connected, or via network 10 to which they are both connected. In a still further embodiment, the separate computing device or system acts as an agent for the receipt, storage and retrieval of such recipient information as explained elsewhere herein.

In a yet further optional embodiment, the recipient key phrase is encoded before being stored.

In step 204, sender creates a new email message using sender computing device 105. As explained elsewhere herein, although this newly created email message may be responding to some previous email, inquiry, or communication from recipient, it is asynchronous and not part of any existing message thread.

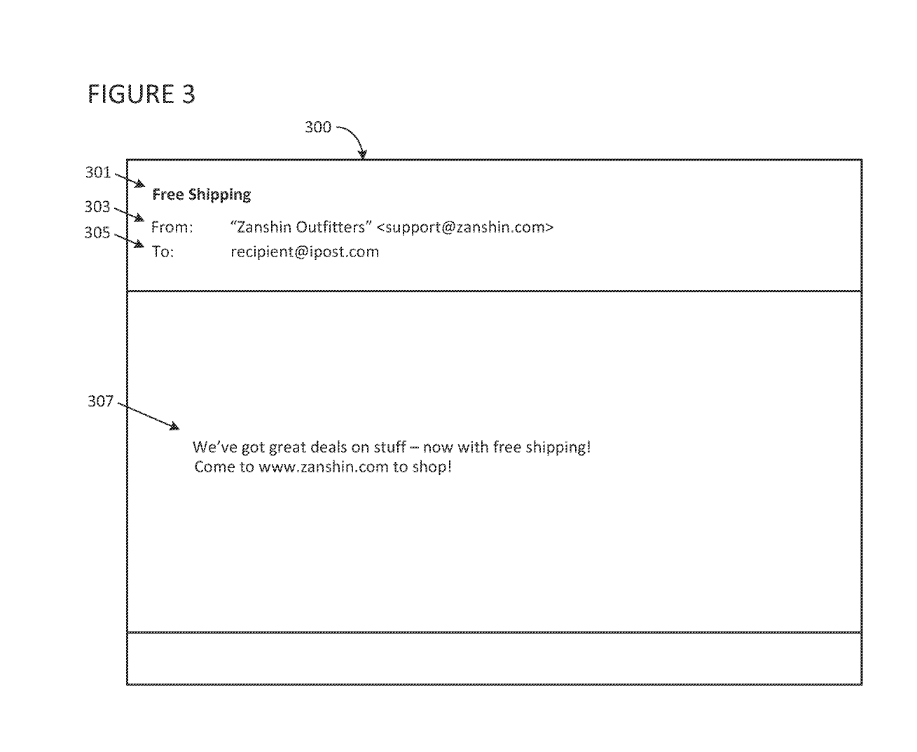

Referring now to FIG. 3, an example new email message 300 as may be created in step 204 of FIG. 2 can be seen. Email message 300, as with any email message known in the art, contains a number of elements and fields as will now be described. Email message 300 contains a subject line field 301 entitled “Free Shipping” which is a brief summary of the topic of the message. Email message 300 contains a from field 303 of “‘Zanshin Outfitters’ <support@zanshin.com>” indicating an email address, and optionally a name, of the sender of the email message. Email message 300 contains a to field 305 of “recipient@ipost.com” indicating the email address, and optionally a name, of the recipient of the email message. Email message 300 contains a message body 307 of “We've got great deals on stuff—now with free shipping! Come to www.zanshin.com to shop!” which is the general content, in unstructured text, of the email message. Although not shown, other email message elements and fields may also be included as part of email message 300, as is known in the art.

Referring back to FIG. 2, in step 205, sender computing device 105 retrieves the recipient provided key phrase stored in database 107.

In one embodiment, this is accomplished by querying database 107 using recipient's email address being used in the email created in step 204. In this or an alternative embodiment in which an agent stores the recipient provided information, this is accomplished by sender computing device 105 requesting the agent retrieve and provide the recipient key phrase.

Further, if the retrieved key phrase was encoded in step 203, it is now decoded by sender computing device 105 or the agent as appropriate.

In step 206, sender computing device 105 inserts the retrieved key phrase into the new email message.

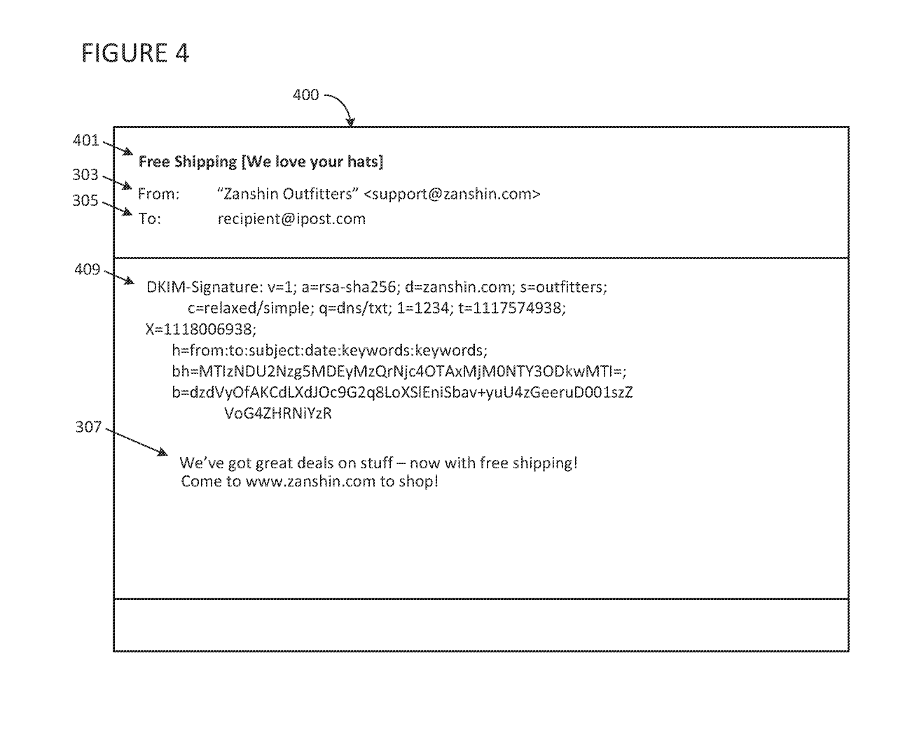

In one embodiment, inserting the retrieved key phrase into the email message is accomplished by sender computing device 105 inserting the key phrase into the subject line of the email message and is intended to augment rather than replace the existing subject line text. For example, with a recipient provided key phrase of “We love your hats”, and based on subject line field 301 of example email message 300 of FIG. 3, this results in a modified email message 400 having modified subject line field 401 now stating “Free Shipping [We love your hats]”, as shown in FIG. 4.

In an alternative embodiment (not shown), inserting the retrieved key phrase into the email message is accomplished by sender computing device 105 inserting the key phrase into some other field rather than into the subject line of the email message. For example, in one embodiment sender computing device 105 modifies a comment portion of the email message from field 303. This can be accomplished for a single recipient, for example, by the sender manually changing the configuration of the email application program running on sender computing device 105 to add the key phrase to the sender's name. As an alternative, the modification can be performed in an automated fashion by the email application program performing a mail merge from database 107 of recipient information. This would result in the key phrase being placed in from field 303 instead of subject field 301. Modifying from field 303 preserves the benefits of having the key phrase incorporated into the DKIM signature, as explained elsewhere herein, and increases the likelihood that common email readers will prominently display the key phrase on recipient computing device 101.

Once the key phrase has been inserted into the email message, in some embodiments it may be desirable to apply a validation mechanism to the email message to provide some assurance to the recipient that the sender is the same entity to which the recipient originally entrusted the key phrase. Known validation mechanisms include Domain Keys Identified Mail (DKIM), DomainKeys (a predecessor of DKIM), identified Internet Mail, and Secure/Multipurpose Internet Mail Extensions (S/MIME), among other possibilities. Of course, the appropriate validation mechanism by which such assurance is provided may be chosen as appropriate to the implementation. For example, referring again to FIG. 2, in optional step 207, sender computing device 105 processes the new email message with a DKIM signature of the recipient, a process known in the art.

In one embodiment, referring again to FIG. 4, this is accomplished by the email application program running on sender computing device 105 examining message body 307 and some or all of email message 400 header fields to compute a cryptographic signature. In this embodiment, the particular header fields to be used include from field 303, to field 305 and subject field 401 so as to cover the sender's email address, the recipient's email address and the key phrase which, as explained above, is in the subject field. After the signature is computed, it is then encoded using a private component of an asymmetric key pair. The public component of this key pair is advertised by the sender via a Domain Name Service (DNS) for use by recipients.

Processing the new email message with the DKIM signature of the recipient results in adding a DKIM-Signature header field 409 to the email message. The DKIM-Signature header field 409 includes a brief description listing the other fields that were examined, plus a text representation of the encoded signature. Of course, contrary to what is shown in the figure yet understood by those of skill in the art, such a DKIM-Signature header field 409 would not normally be displayed in email message 400, but rather, DKIM-Signature header field 409 would be a hidden field which can be used for additional processing by a recipient as explained elsewhere herein.

Referring again to FIG. 2, in step 208, sender sends the email message with the recipient key phrase, and the optional DKIM signature field, to the recipient.

In one embodiment, this is accomplished by sender computing device sending the email message with the recipient key phrase and the optional DKIM signature field to recipient computing device 101 across network 103 using Simple Mail Transfer Protocol (SMTP), an email communications protocol known in the art.

Upon receipt of the email message, recipient computing device 101 can display the email message to recipient who can then see their key phrase displayed in the subject line of the received email message. Upon such display, the recipient operating recipient computing device 101 can readily observe their key phrase displayed in the subject line of the email message and can compare that to the sender identified in the from field of the email message. Based on this, the recipient can then make a quick judgment of the trustworthiness and value of the email message without having to view the entirety of the email message or even the email message body itself.

In a further embodiment utilizing optional DKIM-Signature header field 409, before displaying the received email message on recipient computing device 101, the email application program running on recipient computing device 101 would make a request of the sender's DNS server to obtain the public component of the asymmetric key pair. Recipient computing device 101 then uses the information in DKIM-Signature field 409 to recompute the signature, then decodes the encoded signature from DKIM-Signature field 409 by using the sender's public key. Then recipient computing device 101 compares the result of the decoding with its own signature computation. If the signature computed by recipient computing device 101 matches the signature in the email message's DKIM-Signature header field, the email message is considered verified, which recipient computing device 101 can indicate in a variety of ways, thus assuring the recipient that the expected sender used the recipient's key phrase in its intended manner.

In a still further embodiment, recipient computing device 101 can assist the recipient by displaying an indication such as a graphical icon that the received email message was correctly signed with DKIM. Similarly, recipient computing device 101 can apply a filter to the email message to confirm that it is a trusted communication and only then place the email message in the recipient's email inbox, or otherwise alter the handling of the email message, instead of placing it in a junk folder.

In a yet further embodiment, sender computing device 105 is configured to receive a new, or updated, recipient provided key phrase. In such embodiment, the newly provided key phrase can simply replace the previously provided key phrase or can be placed in a pending status until the recipient confirms the newly provided key phrase either by responding to a new email message from the sender requesting such confirmation or via a confirmation web page of the sender.

In a yet further still embodiment, sender computing device 105 is configured to accept revocation by a recipient of a previously provided key phrase. In such embodiment, such revocation can occur either by responding to a new email message from the sender or via a revocation web page of the sender.

One of skill in the art will understand that the trusted electronic communications of the embodiments described herein can also be conducted in the context of email messaging through known email functions such as forwarding messages to additional message recipients, blind carbon copying (bcc'ing) additional message recipients, replying to message senders while carbon copying (cc'ing) additional message recipients, etc.

The disclosed method and apparatus has been explained herein with reference to several embodiments. Other embodiments will be apparent to those skilled in the art in light of this disclosure. Certain aspects of the described method and apparatus may readily be implemented using configurations other than those described in the embodiments herein, or in conjunction with elements other than those described herein.

Further, it should also be appreciated that the described method and apparatus can be implemented in numerous ways, including as a process, an apparatus, or a system. The methods described herein may be implemented by program instructions for instructing a processor to perform such methods, and such instructions recorded on a computer readable storage medium such as a hard disk drive, floppy disk, optical disc such as a compact disc (CD) or digital versatile disc (DVD), flash memory, etc., or a computer network wherein the program instructions are sent over optical or electronic message links. It should be noted that the order of the steps of the methods described herein may be altered and still be within the scope of the disclosure.

It is to be understood that the examples given are for illustrative purposes only and may be extended to other implementations and embodiments with different conventions and techniques. While a number of embodiments are described, there is no intent to limit the disclosure to the embodiment(s) disclosed herein. On the contrary, the intent is to cover all alternatives, modifications, and equivalents apparent to those familiar with the art. For example, although examples herein describe electronic communications in the form of email messages, other forms of electronic communications are expressly contemplated. For example, an electronic text message could likewise include a recipient provided key phrase within the body of the text message. In this example, the recipient telephone number or email address is the equivalent of the recipient provided email address in the above examples. As another example, an electronically generated facsimile transmission could likewise include a recipient provided key phrase in a field of a cover page of the facsimile transmission. In this example, the recipient facsimile number is the equivalent of the recipient provided email address in the above examples. These further examples make clear that the techniques and approach described herein is applicable to a wide range of electronic communications and communication channels, both now known and later developed.

In the foregoing specification, the invention is described with reference to specific embodiments thereof, but those skilled in the art will recognize that the invention is not limited thereto. Various features and aspects of the herein-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A trusted electronic communication method comprising:
generating, by a computing device of a message sender, an email message to be sent to a computing device of a message recipient wherein the email message is not part of an existing electronic communication message thread with the message recipient;
retrieving, by the computing device of the message sender, a stored key phrase previously provided by the message recipient;
adding, by the computing device of the message sender, the retrieved key phrase to a prominent location within the email message;
and
sending, from the computing device of the message sender to the computing device of the message recipient, the email message with the added key phrase.

2. The trusted electronic communication method of claim 1 wherein the key phrase previously provided by the message recipient was provided using a sender's form webpage.

3. The trusted electronic communication method of claim 1 wherein the key phrase previously provided by the message recipient was provided in an email message sent from the computing device of the recipient to the computing device of the sender.

4. The trusted electronic communication method of claim 1 wherein the key phrase previously provided by the message recipient was provided in a hardcopy form to the sender and manually entered into the computing device of the sender.

5. The method of claim 1 wherein retrieving the stored key phrase uses an email address of the message recipient to query a database of stored key phrases.

6. The method of claim 5 wherein the database of stored key phrases is connected to the computing device of the message sender.

7. The method of claim 5 wherein the database of stored key phrases is operated by an agent and the database of stored key phrases is coupled to the computing device of the message through a network.

8. The method of claim 2 wherein the prominent location within the email message is a subject field of the email message.

9. The method of claim 2 wherein the prominent location within the email message is a comment portion of a message sender field of the email message.

10. The method of claim 1 wherein sending the email message is accomplished using Simple Mail Transfer Protocol (SMTP).

11. The method of claim 1 further comprising applying a validation mechanism to the email message after the step of adding the key phrase to a prominent location within the email message and before the step of sending the email message with the added key phrase.

12. The method of claim 11 wherein applying the validation mechanism comprises adding a DKIM header field.

13. A non-transitory computer readable medium having stored thereupon computing instructions comprising:
a code segment to generate, by a computing device of a message sender, an email message to be sent to a computing device of a message recipient wherein the email message is not part of an existing electronic communication message thread with the message recipient;
a code segment to retrieve, by the computing device of the message sender, a stored key phrase previously provided by the message recipient;
a code segment to add, by the computing device of the message sender, the retrieved key phrase to a prominent location within the email message;
and
a code segment to send, from the computing device of the message sender to the computing device of the message recipient, the email message with the added key phrase.
